(19) United States
(12) Patent Application Publication
(10) Pub. No.: US 2017/0169680 A1
(43) Pub. Date: Jun. 15, 2017

(54) COMPUTER-READABLE RECORDING MEDIUM, MOBILE TERMINAL DEVICE, AND ARTICLE MANAGEMENT METHOD

(71) Applicant: FUJITSU LIMITED, Kawasaki-shi (JP)

(72) Inventors: TOMOHIRO NAKAJIMA, Kawasaki (JP); HISATOSHI YAMAOKA, Kawasaki (JP); KOHEI KUBOTA, Kawasaki (JP); Atsushi MURAMATSU, Kawasaki (JP); Satoshi MATSUYUKI, Fukuoka (JP)

(73) Assignee: FUJITSU LIMITED, Kawasaki-shi (JP)

(21) Appl. No.: 15/297,887

(22) Filed: Oct. 19, 2016

(30) Foreign Application Priority Data
Dec. 15, 2015 (JP) 2015-244466

(51) Int. Cl. G08B 13/24; G06K 19/07; H04W 4/00

(52) U.S. Cl. CPC G08B 13/2462; H04W 4/008; G06K 19/0719

(57) ABSTRACT

An article management program causes a computer to execute a process including: receiving, from a plurality of articles each including a sensor that detects a movement state of each of the articles, a sensor signal that includes therein identification information on an article and a sensor value of the sensor; and displaying, based on the received sensor signal, display information that indicates in a comparable way a change in the sensor value related to each of the plurality of the articles and the identification information on each of the articles.

### CROSS-REFERENCE TO RELATED APPLICATION

This application is based upon and claims the benefit of priority of the prior Japanese Patent Application No. 2015-244466, filed on Dec. 15, 2015, the entire contents of which are incorporated herein by reference.

### FIELD

The embodiments discussed herein are related to a computer-readable recording medium, a mobile terminal device, and an article management method.

### BACKGROUND

In recent years, articles are sometimes managed by mounting a wireless tag, such as Bluetooth (registered trademark) or the like, that can perform wireless communication on each of the articles and by using wireless communication between the wireless tags and a mobile terminal device. Specifically, it is conceivable that by, for example, the mobile terminal device receiving identification information on the articles from the corresponding wireless tags, the mobile terminal device identifies the articles near the mobile terminal device or estimates the distance between the mobile terminal device and the articles on the basis of the radio wave intensity at the time of the reception of the identification information.

Recently, wireless tags with a built-in acceleration sensor are also developed and technologies related to Internet of Things (IoT) in which wireless tags are mounted on various kinds of articles and the articles are connected to the Internet are actively studied. By using IoT, articles can be managed or controlled from a remote place.

Patent Document 1: Japanese Laid-open Patent Publication No. 2004-334439

Patent Document 2: Japanese Laid-open Patent Publication No. 2005-56177

Patent Document 3: Japanese Laid-open Patent Publication No. 2007-256180

The management of the articles by using each of the wireless tags is also useful when managing personal belongings. For example, a wireless tag is mounted on each of the articles that are daily used by a user and, when the user uses these articles, the position of the articles can be searched by a mobile terminal device, such as a smart phone, held by the user.

However, if the number of articles on each of which a wireless tag is mounted is increased, there is a problem in that management of the personal belongings of the user becomes complicated. Namely, with the development of reducing the size and manufacturing costs, it is conceivable that a wireless tag is mounted on each of the large number of articles held by persons. Consequently, for example, if the positions of articles present around the mobile terminal device are searched, the positions of the large number of articles are searched and thus it takes time to specify the position of the desired article from the position list of these articles.

Furthermore, for example, if a list of articles on each of which a wireless tags is mounted is output, pieces of identification information on the large number of articles are disorderly listed and thus it is difficult to efficiently manage the articles. In this way, if a wireless tag is mounted on each of the large number of articles, the usability of the wireless tags is not able to be sufficiently used and management of the article becomes complicated.

### SUMMARY

According to an aspect of an embodiment, a non-transitory computer-readable recording medium stores therein an article management program. The article management program causes a computer to execute a process including: receiving, from a plurality of articles each including a sensor that detects a movement state of each of the articles, a sensor signal that includes therein identification information on an article and a sensor value of the sensor; and displaying, based on the received sensor signal, display information that indicates in a comparable way a change in the sensor value related to each of the plurality of the articles and the identification information on each of the articles.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of an article management system according to a first embodiment;

FIG. 2 is a block diagram illustrating the configuration of a mobile terminal device according to the first embodiment;

FIG. 3 is a block diagram illustrating the function of a processor according to the first embodiment;

FIG. 4 is a schematic diagram illustrating a specific example of a target list;

FIG. 5 is a schematic diagram illustrating a specific example of a group list;

FIG. 6 is a block diagram illustrating the function of a similarity determination unit according to the first embodiment;

FIG. 7 is a flowchart illustrating an article management process according to the first embodiment;

FIG. 8 is a schematic diagram illustrating a specific example of display information;

FIG. 9 is a block diagram illustrating the function of a similarity determination unit according to a second embodiment;

FIG. 10 is a flowchart illustrating an article management process according to the second embodiment;

FIG. 11 is a block diagram illustrating the function of a similarity determination unit according to a third embodiment;

FIG. 12 is a flowchart illustrating an article management process according to the third embodiment;

FIG. 13 is a block diagram illustrating the function of a processor according to a fourth embodiment;

FIG. 14 is a flowchart illustrating an alert notification process according to the fourth embodiment;

FIG. 15 is a block diagram illustrating the function of a processor according to a fifth embodiment; and

FIG. 16 is a flowchart illustrating an article management process according to the fifth embodiment.

### DESCRIPTION OF EMBODIMENTS

Preferred embodiments of the present invention will be explained with reference to accompanying drawings. The present invention is not limited to the embodiments.

### [a] First Embodiment

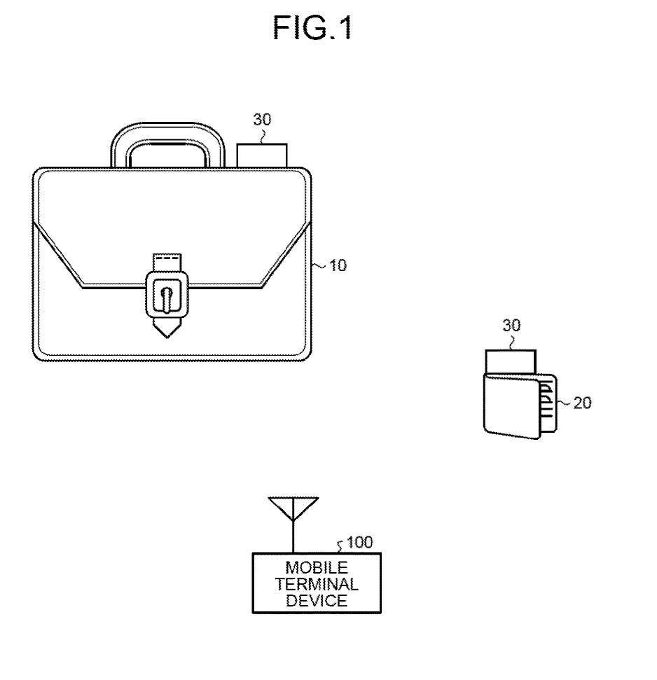

FIG. 1 is a schematic diagram illustrating an example of an article management system according to a first embodiment. In the article management system illustrated in FIG. 1, the articles, such as a bag 10 and a wallet 20, are managed by a mobile terminal device 100. Namely, a wireless tag 30 is mounted on each of the articles, such as the bag 10 and the wallet 20.

Each of the wireless tags 30 includes, for example, a three-axis acceleration sensor and a wireless interface that can perform wireless communication using Bluetooth Low Energy (BLE). Then, each of the wireless tags 30 temporarily accumulates sensor values of a three-axis acceleration sensor in order to record the speed or the direction of the movement of the articles. Then, each of the wireless tags 30 periodically sends, from a wireless interface, a sensor signal that includes therein both the identification information on each of the articles and the accumulated sensor values.

The mobile terminal device 100 receives the sensor signal sent from each of the wireless tags 30 and manages the articles, such as the bag 10, the wallet 20, and the like. At this time, the mobile terminal device 100 determines, on the basis of the sensor values included in the sensor signal, a movement state that indicates whether each of the articles is moving or stands still and groups the articles that have similar movement states. In this way, by grouping the articles using the movement states, the mobile terminal device 100 efficiently manages the articles on each of which the wireless tag 30 is mounted. The management of the articles performed by the mobile terminal device 100 will be described in detail later.

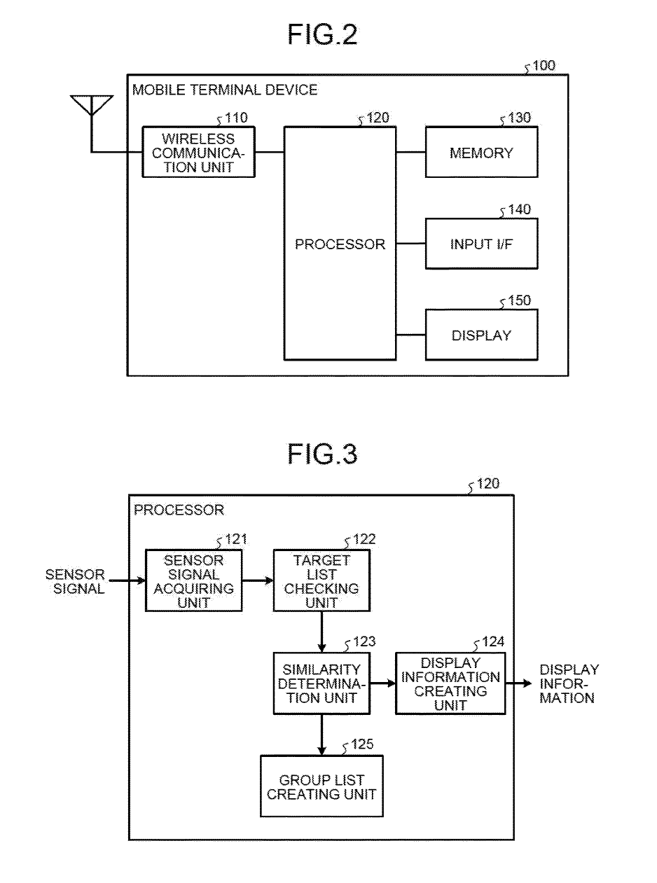

FIG. 2 is a block diagram illustrating the configuration of the mobile terminal device 100 according to the first embodiment. The mobile terminal device 100 illustrated in FIG. 2 includes a wireless communication unit 110, a processor 120, a memory 130, an input interface (hereinafter, simply referred to as an “input I/F”) 140, and a display 150.

The wireless communication unit 110 performs wireless communication using, for example, BLE and receives a sensor signal sent from the wireless tag 30 that is mounted on each of the articles. Then, the wireless communication unit 110 outputs the received sensor signal to the processor 120.

The processor 120 includes, for example, a central processing unit (CPU), a field programmable gate array (FPGA), a digital signal processor (DSP), or the like and performs the overall control of the entirety of the mobile terminal device 100. Namely, the processor 120 performs various kinds of processes by using the memory 130. Specifically, the processor 120 determines, on the basis of the sensor values included in the sensor signal, the movement state of each of the article and groups the articles that have similar movement states. The function of the processor 120 will be described in detail later.

The memory 130 includes, for example, a random access memory (RAM), a read only memory (ROM), or the like and stores therein various kinds of information at the time of process performed by the processor 120.

The input I/F 140 includes, for example, a touch panel, a physical key, a microphone, or the like and accepts an operation input performed by a user. Then, the input I/F 140 notifies the processor 120 of the accepted operation input.

The display 150 includes, for example, a liquid crystal panel, or the like and displays display information that is output from the processor 120. The display 150 may also be arranged to be overlapped with a touch panel that is included in the input I/F 140.

FIG. 3 is a block diagram illustrating the function of the processor 120 according to the first embodiment. The processor 120 illustrated in FIG. 3 includes a sensor signal acquiring unit 121, a target list checking unit 122, a similarity determination unit 123, a display information creating unit 124, and a group list creating unit 125.

The sensor signal acquiring unit 121 acquires a sensor signal received by the wireless communication unit 110. The sensor signal acquired by the sensor signal acquiring unit 121 is a signal that is periodically sent from the wireless tag 30 that is mounted on each of the articles and that includes therein both the identification information on the corresponding article and the sensor values of the three-axis acceleration sensor. The sensor signal acquiring unit 121 acquires the sensor signals sent from all of the articles that are present in the communication zone of the communication with the mobile terminal device 100.

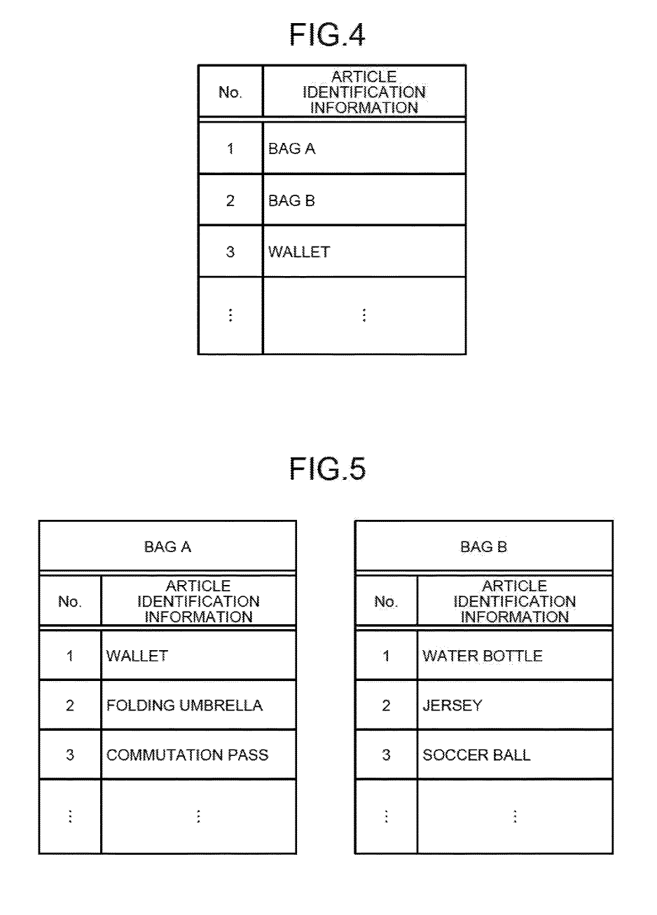

The target list checking unit 122 checks the identification information included in the sensor signal against the target list stored in the memory 130. Namely, the target list checking unit 122 acquires, from the memory 130, the target list indicating the list of the target articles that are managed by the mobile terminal device 100 and determines whether the article of the transmission source of the sensor signal corresponds to the management target. The target list acquired by the target list checking unit 122 from the memory 130 stores therein, for example, as illustrated in FIG. 4, identification information on all of the articles targeted for the management. This target list may be created by a user registering, in the mobile terminal device 100, for example, the identification information on the articles that are registered in the corresponding wireless tag 30. In the target list illustrated in FIG. 4, as the identification information on the articles, the names of the articles, for example, a “bag A”, a “bag B”, a “wallet”, or the like are stored.

If the result of checking the identification information included in the sensor signal against the identification information included in the target list indicates that the identification information included in the sensor signal is included in the target list, the target list checking unit 122 notifies the similarity determination unit 123 of the identification information and the sensor values.

The similarity determination unit 123 compares the sensor values of the articles targeted for the management and determines whether the movement states of the articles are similar. Namely, the similarity determination unit 123 decides, on the basis of the sensor values notified from the target list checking unit 122, the movement states each of which indicates whether the article is moving or standing still and determines whether the movement states of the articles are similar. At this time, the similarity determination unit 123 accumulates a predetermined number of sensor signals that are periodically sent from each of the articles and calculates the likelihood of the movement of each of the articles (hereinafter, referred to as the “movement likelihood”) from the sensor value for each article. Then, if a difference of the movement likelihood between the articles is less than a predetermined threshold, the similarity determination unit 123 determines that both of these articles are moving. In contrast, if a difference of the movement likelihood between the articles is equal to or greater than a predetermined threshold, the similarity determination unit 123 determines that both of these articles are not moving. In this way, the similarity determination unit 123 determines that the articles whose movement states are similar are the articles in the same group and determines that the articles whose movement states are not similar are the articles that are not in the same group. Furthermore, the similarity determination unit 123 will be described in detail later.

The display information creating unit 124 creates, on the basis of the determination result obtained by the similarity determination unit 123, the display information to be displayed on the display 150. Specifically, the display information creating unit 124 graphs the sensor values related to, for example, each of the articles and creates display information in which graphs of the articles whose movement states are similar are adjacently arranged. Namely, the display information creating unit 124 creates display information in which graphs of the sensor values related to both the articles that are determined to be moved are arranged together with the identification information. Then, the display information creating unit 124 outputs the created display information to the display 150 and displays the information on the display 150.

The group list creating unit 125 creates, on the basis of the determination result obtained by the similarity determination unit 123, a group list that indicates the group of the articles. Specifically, the group list creating unit 125 creates, for each article, the group list that indicates the list of the articles whose movement state are similar to the subject article. Accordingly, the group list creating unit 125 creates, for example, as illustrated in FIG. 5, regarding each of the articles, the group list that indicates the list of articles that were determined to have been moved together. In the example illustrated in FIG. 5, the group list of a “bag A” stores therein identification information, such as a “wallet”, a “folding umbrella”, a “commutation pass”, and the like and the group list of a “bag B” stores therein identification information, such as a “water bottle”, a “jersey”, a “soccer ball”, and the like. Because the group list is the list in which the articles in the same group are enumerated for each article, the identification information on the article belonging to the same group is included in the counterpart group list. For example, in the example illustrated in FIG. 5, because the “wallet” is included in the group list of the “bag A”, the “bag A” is included in the group list of the “wallet”.

Furthermore, after the display information created by the display information creating unit 124 is displayed on the display 150, the group list creating unit 125 may also change the group list in accordance with the operation input that is performed by a user and that is accepted by the input I/F 140. Namely, because the display information that indicates the movement state of each of the articles is displayed on the display 150, the user may also decide the articles in the same group from the movement state of or the identification information on each of the articles and performs the operation input that groups the articles. Then, the group list creating unit 125 creates a group list in accordance with the operation input performed by the user, in addition to the determination result obtained by the similarity determination unit 123.

Because the group lists created in this way are the lists of the articles that are simultaneously carried by the user, by managing the articles using the group lists, it is possible to output a carry item list of the user depending on the situation. Furthermore, for example, if the position of a single article is searched, it is possible to simultaneously search for the position of each of the articles that are in the same group as the searching article and it is possible to search the position of all of the articles that are simultaneously carried by the user.

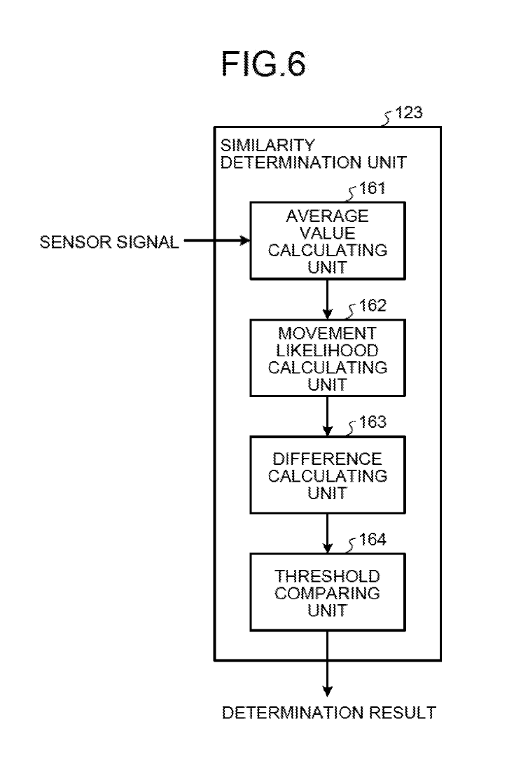

FIG. 6 is a block diagram illustrating the function of the similarity determination unit 123 according to the first embodiment. The similarity determination unit 123 illustrated in FIG. 6 includes an average value calculating unit 161, a movement likelihood calculating unit 162, a difference calculating unit 163, and a threshold comparing unit 164.

The average value calculating unit 161 calculates the average value of the sensor values obtained, within a predetermined time period, from the sensor signal for each article. At this time, if the sensor signal includes the sensor values of, for example, a three-axis acceleration sensor, the average value calculating unit 161 uses the sum of the square of the sensor values of the three-axis acceleration sensor as the sensor values and calculates, for each article, the average value of these sensor values.

The movement likelihood calculating unit 162 calculates the movement likelihood for each article on the basis of both the instantaneous value of the sensor value for each article and the average value calculated by the average value calculating unit 161. Specifically, the movement likelihood calculating unit 162 calculates, for each article, the total sum of the differences between each of the instantaneous values of the sensor values and the average value as the movement likelihood. If an article moves, because the sensor value of the wireless tag 30 mounted on the subject article varies, the movement likelihood that is the total sum of the differences between the instantaneous values of the sensor values and the average values becomes large. Accordingly, the value of the movement likelihood becomes greater as the article moves more frequently.

The difference calculating unit 163 calculates a difference between the movement likelihood for each article. Because the movement likelihood is the value that designates the movement state indicating whether the article has been moved, the values of the movement likelihood of the articles that are simultaneously move and have similar movement states tend to be similar and the difference of the movement likelihood is decreased.

The threshold comparing unit 164 compares the difference calculated by the difference calculating unit 163 with the predetermined threshold. Then, the threshold comparing unit 164 decides that the articles in which the difference of the movement likelihood is less than the predetermined threshold were moving together and determines that the movement states of these articles are similar. In contrast, the threshold comparing unit 164 decides that the articles in which the difference of the movement likelihood is equal to or greater than the predetermined threshold were not moving together and determines that the movement states of these articles are not similar. The threshold comparing unit 164 outputs the determination result to the display information creating unit 124 and the group list creating unit 125.

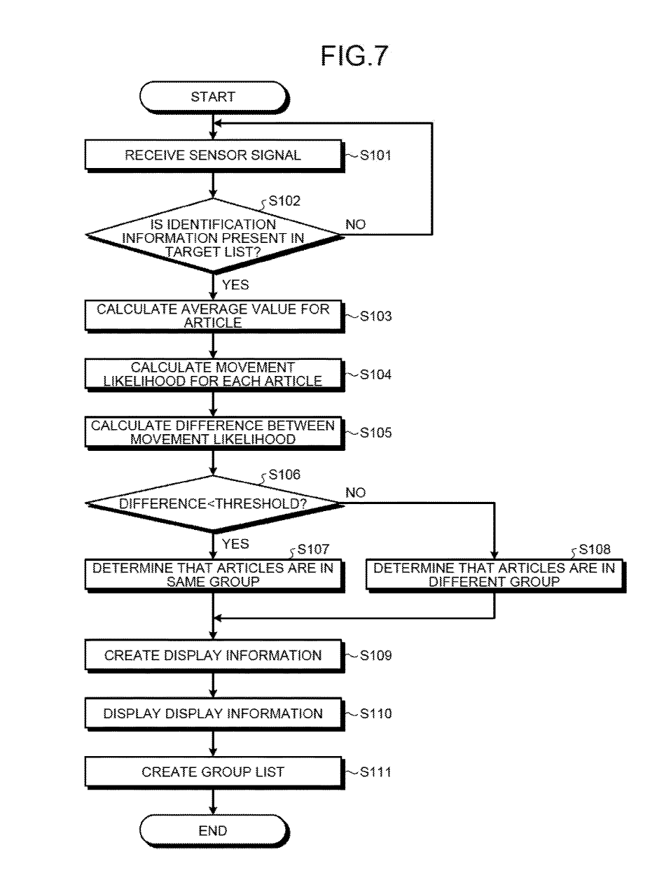

In the following, an article management process performed by the mobile terminal device 100 configured as described above will be described with reference to the flowchart illustrated in FIG. 7. In this article management process, the articles that are mainly and simultaneously carried by a user are grouped and group lists are created.

The sensor signal that includes therein both the identification information on the article and the accumulated sensor values of the three-axis acceleration sensor is periodically sent from the wireless tag 30 mounted on the article. Then, the sensor signal sent from the wireless tag 30 mounted on the article that is positioned within the communication zone of the mobile terminal device 100 is received by the wireless communication unit 110 (Step S101). The received sensor signal is acquired by the sensor signal acquiring unit 121 in the processor 120. Then, the identification information included in the sensor signal is checked against the identification information on the target list by the target list checking unit 122 (Step S102).

If the result of checking against the target list indicates that the identification information included in the sensor signal is not included in the target list (No at Step S102), the article of the transmission source of this sensor signal is the article or the like that is not, for example, the personal belongings of the user; therefore, the article is ignored as the out of the management target. In contrast, if the identification information included in the sensor signal is included in the target list (Yes at Step S102), the average value of the sensor values is calculated for each article by the average value calculating unit 161 in the similarity determination unit 123 (Step S103). Namely, the average value is calculated for each article by the average value calculating unit 161 from the sensor values measured by the three-axis acceleration sensor of the wireless tag 30 within a predetermined time period.

Then, the movement likelihood for each article is calculated by the movement likelihood calculating unit 162 (Step S104). Specifically, the total sum of the difference between a plurality of the instantaneous values and the average values of the sensor values is calculated for each article. If an article is moving, because the difference between the instantaneous values and the average value of the sensor values tends to be great, the movement likelihood becomes greater as the article is moving.

If the movement likelihood is calculated for each article, the difference between the movement likelihood is calculated for each article by the difference calculating unit 163 (Step S105). If the movement states of the articles are similar, because the values of the movement likelihood are close to each other, the difference of the movement likelihood between both the articles that are moving together is decreased. Thus, the difference of the movement likelihood is compared with the predetermined threshold by the threshold comparing unit 164 (Step S106).

If the comparison result indicates that the difference of the movement likelihood is less than the predetermined threshold (Yes Step S106), the threshold comparing unit 164 decides that both the articles having the movement likelihood are moving together and belong to the same group (Step S107). Furthermore, if the difference of the movement likelihood is equal to or greater than the predetermined threshold (No at Step S106), the threshold comparing unit 164 decides that both the articles having the movement likelihood are not moving together and belong to different groups (Step S108). The determination of the similarity of the movement states of the articles performed in this way is performed for each of the combinations of two articles and the determination result related to each of the combinations is output to the display information creating unit 124 and the group list creating unit 125.

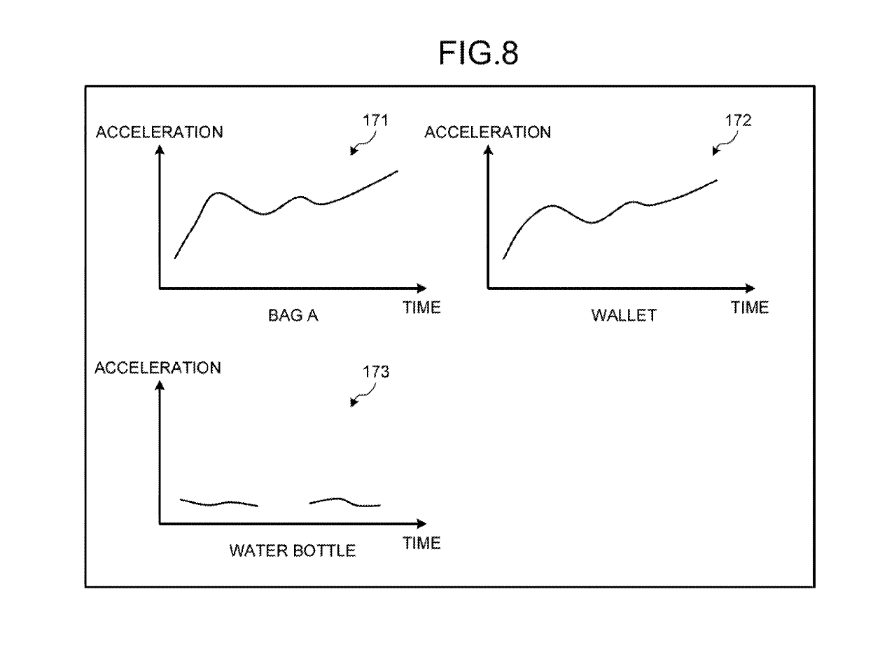

Then, the display information on the basis of the determination result of the similarity is created by the display information creating unit 124 (Step S109). Specifically, the sensor values of each of the articles are graphed by the display information creating unit 124 and the display information in which the graphs of articles that are in the same group and whose movement states are similar are adjacently arranged together with the identification information on the articles. Namely, for example, as illustrated in FIG. 8, the display information in which the graphs of the sensor values for each article are arranged in accordance with the similarity of the movement states. In the example illustrated in FIG. 8, because the movement state of the “bag A” is similar to the movement state of the “wallet”, a graph 171 and a graph 172 of these articles are adjacently arranged together with the identification information on each of the articles. In contrast, because the movement state of the “water bottle” is not similar to the movement states of the “bag A” and the “wallet”, a graph 173 corresponding to the identification information on the “water bottle” is arranged at the position that is different from the graph 171 and the graph 172.

The display information illustrated in FIG. 8 is an example and the graph does not always need to be included in the display information. For example, instead of the graphs, sensor values related to each of the articles may also be arranged in the tabular format or identification information on the articles may also be enumerated and arranged for each group in which the movement states are similar.

A description will be given here by referring back to FIG. 7. The display information created by the display information creating unit 124 is output to the display 150 and displayed (Step S110). Because the display information is displayed on the display 150, a user can visually confirm the group of the articles that have the similar movement states. Consequently, the user can input, to the input I/F 140, the combination or the like of the articles desired to be added to the same group regardless of, for example, the movement state.

In contrast, if the determination result of the similarity of the movement states of the articles is output to the group list creating unit 125, a group list is created by the group list creating unit 125 (Step S111). Specifically, a group list in which the identification information on the articles that have the similar movement states is enumerated for each article. At this time, if an operation input to the input I/F 140 is performed by the user who visually confirms the display information, the group list is changed in accordance with the operation input performed by the user. Namely, in addition to the articles that have the similar movement states, a group list in which the article specified by the user belongs to the same group is created.

Consequently, the group list in which the articles that are mainly and simultaneously carried by the user and that are in the same group is created for each article and the articles that are simultaneously carried by the user can be collectively managed. Consequently, for example, it is possible to output the list of the articles that are simultaneously carried by the user depending on the situation, such as commutation or a business trip, or it is also possible to simultaneously search the position of the articles that are simultaneously carried by the user when searching the position of a single article.

As described above, according to the embodiment, the movement likelihood of each of the articles is obtained from the sensor values that are collected from the wireless tag mounted on each of the articles is obtained and the articles in which the difference of the movement likelihood is small and the movement states are similar are grouped in the same group. Consequently, the articles that are simultaneously carried by the user can be collectively managed in the same group and the articles on each of which the wireless tag is mounted can be efficiently managed.

### [b] Second Embodiment

The characteristic of a second embodiment is that a movement period in which, in transition of the sensor values, an article is assumed to be moving is detected and it is determined whether the movement states of the articles are similar on the basis of the frequency analysis of each of the waveforms of the sensor values in the movement period.

The configuration of a mobile terminal device according to the second embodiment is the same as that of the mobile terminal device 100 (FIGS. 2 and 3) according to the first embodiment; therefore, descriptions thereof will be omitted. In the second embodiment, the function of the similarity determination unit 123 is different from that described in the first embodiment.

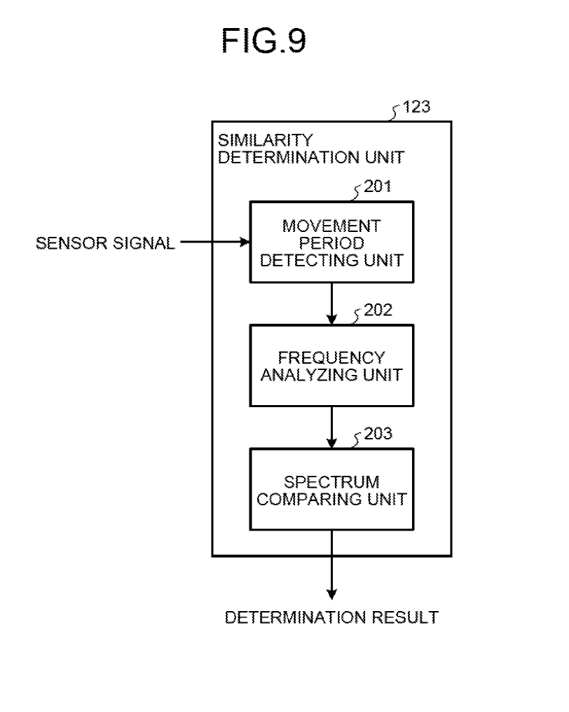

FIG. 9 is a block diagram illustrating the function of the similarity determination unit 123 according to a second embodiment. The similarity determination unit 123 illustrated in FIG. 9 includes a movement period detecting unit 201, a frequency analyzing unit 202, and a spectrum comparing unit 203.

The movement period detecting unit 201 detects, in transition of a plurality of the sensor values obtained from a plurality of the sensor signals for each article, a movement period in which the article is assumed to be moving. Specifically, the movement period detecting unit 201 detects, as the movement period, the section in which the sensor values are equal to or greater than the predetermined threshold. At this time, if the sensor signal includes the sensor values of, for example, the three-axis acceleration sensor, the movement period detecting unit 201 uses the sum of the square of the sensor values of the three-axis acceleration sensor as the sensor values and detects the movement period by comparing this sensor values with the predetermined threshold.

The frequency analyzing unit 202 performs the frequency analysis on the waveform of the sensor value in the movement period detected by the movement period detecting unit 201. Specifically, by performing Fourier transformation on the waveform of, for example, sensor value, the frequency analyzing unit 202 obtains, for each article, the spectrum of the waveform of the sensor value.

The spectrum comparing unit 203 compares the spectrum for each article obtained by the frequency analyzing unit 202. Then, if the spectrum distribution for each article satisfies a predetermined similarity criterion, the spectrum comparing unit 203 determines that the movement states of these articles are similar. In contrast, if the spectrum distribution for each article does not satisfy a predetermined similarity criterion, the spectrum comparing unit 203 determines that the movement states of these articles are not similar. The spectrum comparing unit 203 outputs the determination result to the display information creating unit 124 and the group list creating unit 125.

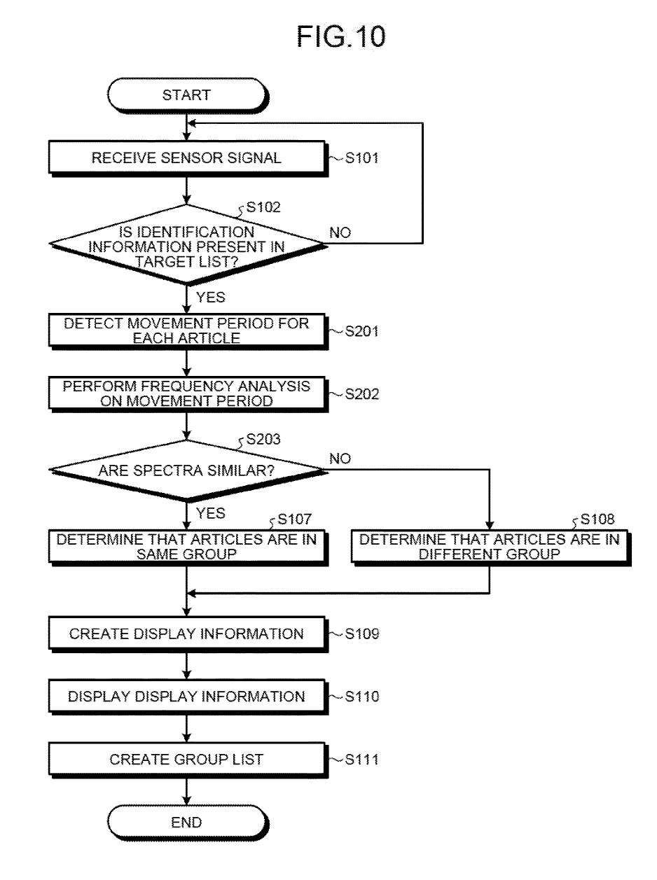

In the following, an article management process performed by the mobile terminal device 100 configured as described above will be described with reference to the flowchart illustrated in FIG. 10. In FIG. 10, components having the same configuration as those illustrated in FIG. 7 are assigned the same reference numerals and descriptions thereof in detail will be omitted.

The sensor signal sent from the wireless tag 30 mounted on the article that is positioned in the communication zone of the mobile terminal device 100 is received by the wireless communication unit 110 (Step S101). Then, the identification information included in the sensor signal is checked against the identification information in the target list by the target list checking unit 122 in the processor 120 (Step S102).

If the result of checking against the target list indicates that the identification information included in the sensor signal is not included in the target list (No at Step S102), the article of the transmission source of this sensor signal is the article or the like that is not, for example, the personal belongings of the user; therefore, the article is ignored as the out of the management target. In contrast, if the identification information included in the sensor signal is included in the target list (Yes at Step S102), the movement period in transition of the sensor value for each article is detected by the movement period detecting unit 201 in the similarity determination unit 123 (Step S201). Namely, the section in which the sensor value is equal to or greater than the predetermined threshold is detected as the movement period by the movement period detecting unit 201.

Then, the frequency analysis is performed, by the frequency analyzing unit 202 for each article, on the waveform of the sensor value in the movement period (Step S202). This frequency analysis is performed to obtain the spectrum of the waveform of the sensor value by using, for example, Fourier transformation; however, another method may also be used as long as an analysis method that can obtain the characteristic in the movement period for each article.

If the spectrum is obtained for each article by the frequency analysis, the spectrum comparing unit 203 determines whether the spectrum of each of the articles satisfies the predetermined similarity criterion (Step S203). If the determination result indicates that the spectrum for each article satisfies the predetermined similarity criterion (Yes at Step S203), the spectrum comparing unit 203 decides that the articles associated with these spectra are moving together and belongs to the same group (Step S107). Furthermore, if the spectrum for each article does not satisfy the predetermined similarity criterion (No at Step S203), the spectrum comparing unit 203 decides that the articles associated with these corresponding spectra are not move together and belong to different groups (Step S108). The determination of the similarity of the movement states of the articles performed in this way is performed for each of the combinations of two articles and the determination result related to each of the combinations is output to the display information creating unit 124 and the group list creating unit 125.

Then, the display information on the basis of the determination result of the similarity is created by the display information creating unit 124 (Step S109). The display information created by the display information creating unit 124 is output to the display 150 and displayed (Step S110). Because the display information is displayed on the display 150, a user can visually confirm the group of the articles that have the similar movement states. Consequently, the user can input, to the input I/F 140, the combination or the like of the articles desired to be added to the same group regardless of, for example, the movement state.

In contrast, if the determination result of the group of the similarity of the movement states of the articles is output to the group list creating unit 125, a group list is created by the group list creating unit 125 (Step S111). At this time, if an operation input to the input I/F 140 is performed by the user who visually confirms the display information, the group list is changed in accordance with the operation input performed by the user.

As described above, according to the embodiment, the movement period of each of the articles is detected from the sensor values that are collected from the wireless tag mounted on each of the articles and articles in which the spectra of the waveforms of the sensor values in the movement period are similar are grouped in the same group. Consequently, the articles that are simultaneously carried by the user can be collectively managed in the same group and the articles on each of which the wireless tag is mounted can be efficiently managed. Furthermore, it is possible to determine the similarity of the movement states of the articles with high accuracy by using the spectra of the waveforms of the sensors in the movement period.

### [c] Third Embodiment

The characteristic of a third embodiment is that a movement period in which, in transition of the sensor values, an article is assumed to be moving is detected and it is determined whether the movement states of the articles are similar to the articles in accordance with whether the starting point and the end point of the movement period of the articles are within a predetermined range.

The configuration of a mobile terminal device according to the third embodiment is the same as that of the mobile terminal device 100 (FIGS. 2 and 3) according to the first and the second embodiments; therefore, descriptions thereof will be omitted. In the third embodiment, the function of the similarity determination unit 123 is different from that described in the first and the second embodiments.

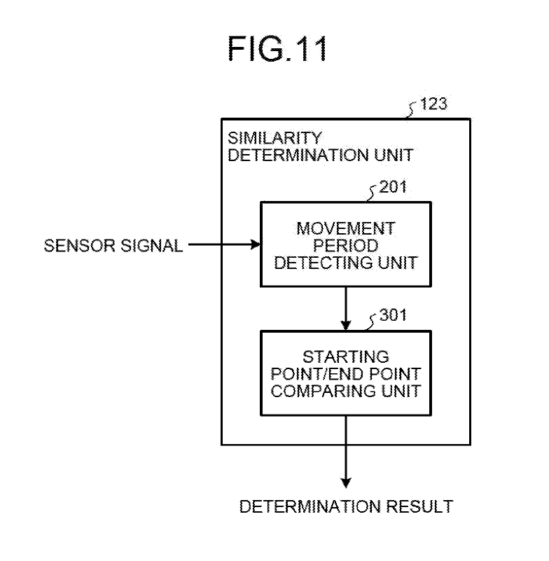

FIG. 11 is a block diagram illustrating the function of the similarity determination unit 123 according to a third embodiment. In FIG. 11, components having the same configuration as those illustrated in FIG. 9 are assigned the same reference numerals and descriptions thereof will be omitted. The similarity determination unit 123 illustrated in FIG. 11 includes a starting point/end point comparing unit 301 instead of the frequency analyzing unit 202 and the spectrum comparing unit 203 in the similarity determination unit 123 illustrated in FIG. 9.

The starting point/end point comparing unit 301 compares the starting point and the end point of the movement period for each article detected by the movement period detecting unit 201. Specifically, the starting point/end point comparing unit 301 compares the positions of the starting point of the movement period for each article and compares the positions of the end point of the movement period for each article. Then, if the starting point of the movement period for each article is within the predetermined range from each of the point and the end point is within the predetermined range from each of the point, the starting point/end point comparing unit 301 determines that the movement states of these articles are similar. In contrast, if at least one of the starting point and the end point of the movement period for each article is not within the predetermined range regarding the articles, the starting point/end point comparing unit 301 determines that the movement states of these articles are not similar. The starting point/end point comparing unit 301 outputs the determination result to the display information creating unit 124 and the group list creating unit 125.

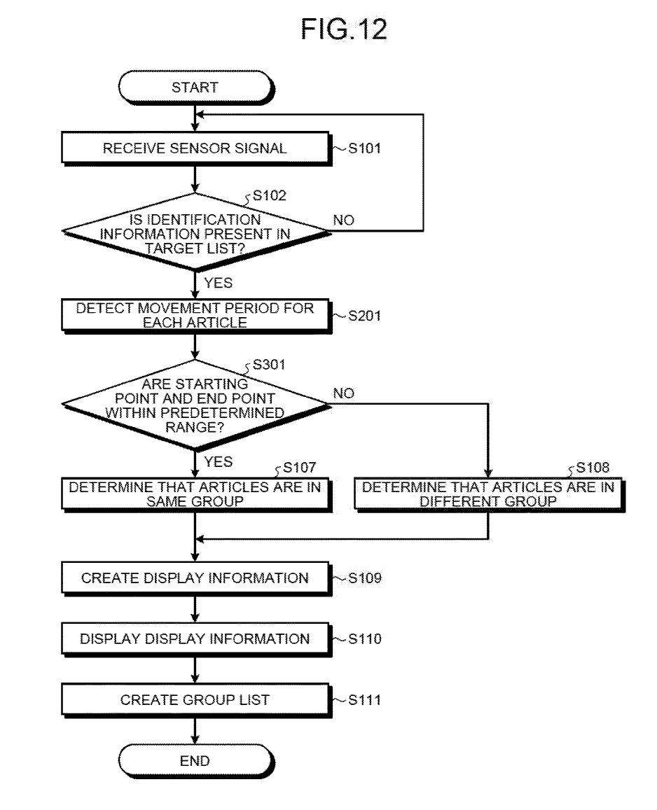

In the following, an article management process performed by the mobile terminal device 100 configured as described above will be described with reference to the flowchart illustrated in FIG. 12. In FIG. 12, components having the same configuration as those illustrated in FIGS. 7 and 10 are assigned the same reference numerals and descriptions thereof in detail will be omitted.

The sensor signal sent from the wireless tag 30 mounted on the article that is positioned in the communication zone of the mobile terminal device 100 is received by the wireless communication unit 110 (Step S101). Then, the identification information included in the sensor signal is checked against the identification information in the target list by the target list checking unit 122 in the processor 120 (Step S102).

If the result of checking against the target list indicates that the identification information included in the sensor signal is not included in the target list (No at Step S102), the article of the transmission source of this sensor signal is the article or the like that is not, for example, the personal belongings of the user; therefore, the article is ignored as the out of the management target. In contrast, if the identification information included in the sensor signal is included in the target list (Yes at Step S102), the movement period in transition of the sensor value for each article is detected by the movement period detecting unit 201 in the similarity determination unit 123 (Step S201).

Then, the positions of the starting point and the end point of the movement period for each article are compared by the starting point/end point comparing unit 301 (Step S301). Specifically, the starting point/end point comparing unit 301 determines whether the starting points of the movement periods of the two articles are within the predetermined range and determines whether the end point of the movement periods of these articles are within the predetermined range. Furthermore, if a plurality of movement periods is detected for each of the articles, the starting points and the end points of all of the movement periods are compared by the starting point/end point comparing unit 301.

If the determination result described above indicates that the starting point and the end point of the movement period for each article are within the predetermined range from each of the points (Yes at Step S301), the starting point/end point comparing unit 301 decides that the articles of this combination are moving together and belong in the same group (Step S107). Furthermore, if at least one of the starting point and the end point of the movement period for each article is not within the predetermined range from each of the points (No at Step S301), the starting point/end point comparing unit 301 decides that the articles of this combination are not moving together and belong to different groups (Step S108). The determination of the similarity of the movement states of the articles performed in this way is performed for each of the combinations of two articles and the determination result related to each of the combinations is output to the display information creating unit 124 and the group list creating unit 125.

Then, display information is created on the basis of the determination result of the similarity by the display information creating unit 124 (Step S109). The display information created by the display information creating unit 124 is output to the display 150 and is displayed (Step S110). Because the display information is displayed on the display 150, a user can visually confirm the group of the articles that have the similar movement states. Consequently, the user can input, to the input I/F 140, the combination or the like of the articles desired to be added to the same group regardless of, for example, the movement state.

In contrast, if the determination result of the group of the similarity of the movement states of the articles is output to the group list creating unit 125, a group list is created by the group list creating unit 125 (Step S111). At this time, if an operation input to the input I/F 140 is performed by the user who visually confirms the display information, the group list is changed in accordance with the operation input performed by the user.

As described above, according to the embodiment, the movement period of each of the articles is detected from the sensor values that are collected from the wireless tag mounted on each of the articles and articles in each of which the starting point of the movement period of the article is within the predetermined range and the end point of the movement period of the article is within the predetermined range are grouped in the same group. Consequently, the articles that are simultaneously carried by the user can be collectively managed in the same group and the articles on each of which the wireless tag is mounted can be efficiently managed. Furthermore, the similarity of the movement state of each of the articles can be determined by using an easy process of comparing the position of the starting point and the end point of the movement period.

### [d] Fourth Embodiment

The characteristic of a fourth embodiment is that, after the group list has been created, whether or not a change is present in a group is monitored and an alert is notified if a change is present.

The configuration of a mobile terminal device according to a fourth embodiment is the same as that of the mobile terminal device 100 (FIG. 2) according to the first embodiment; therefore, descriptions thereof will be omitted. In the fourth embodiment, the function of the processor 120 is different from that described in the first embodiment.

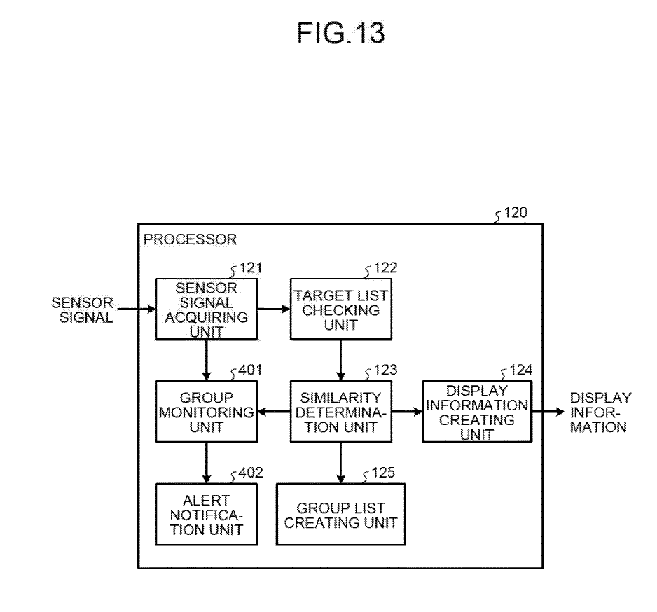

FIG. 13 is a block diagram illustrating the function of the processor 120 according to a fourth embodiment. In FIG. 13, components having the same configuration as those illustrated in FIG. 3 are assigned the same reference numerals and descriptions thereof will be omitted. The processor 120 illustrated in FIG. 13 has the configuration in which a group monitoring unit 401 and an alert notification unit 402 are added to the processor 120 illustrated in FIG. 3.

The group monitoring unit 401 refers to the group list that is created by the group list creating unit 125 and that is stored in the memory 130 and monitors whether the articles indicated in the group list is continuously grouped. Specifically, if a sensor signal of a single article is acquired by the sensor signal acquiring unit 121, the group monitoring unit 401 monitors whether the sensor signals are received within predetermined time from all of the articles that belong to the same group to which the subject article belongs. Then, if the sensor signals from all of the articles in the same group are not received within the predetermined time, the group monitoring unit 401 notifies the alert notification unit 402 of this status.

Furthermore, regarding a plurality of articles belonging to the same group, if the similarity determination of the movement state is performed by the similarity determination unit 123, the group monitoring unit 401 monitors whether the movement states of these articles are similar. Then, if the movement states of the articles in the same group are not similar, the group monitoring unit 401 notifies the alert notification unit 402 of this status.

In accordance with the notification from the group monitoring unit 401, the alert notification unit 402 notifies of an alert that warns that a change is present in a group of the already created group list. Specifically, if sensor signals are received only from some articles belonging to the same group or the movement states of the articles belonging to the same group are not similar, the alert notification unit 402 allows, for example, the display 150 to display a warning message. Furthermore, in addition to allowing the display 150 to display the warning message, the alert notification unit 402 may also notify of an alert by allowing, for example, a speaker to output a warning tone or allowing a light emitting diode (LED) to be flashed in a predetermined pattern.

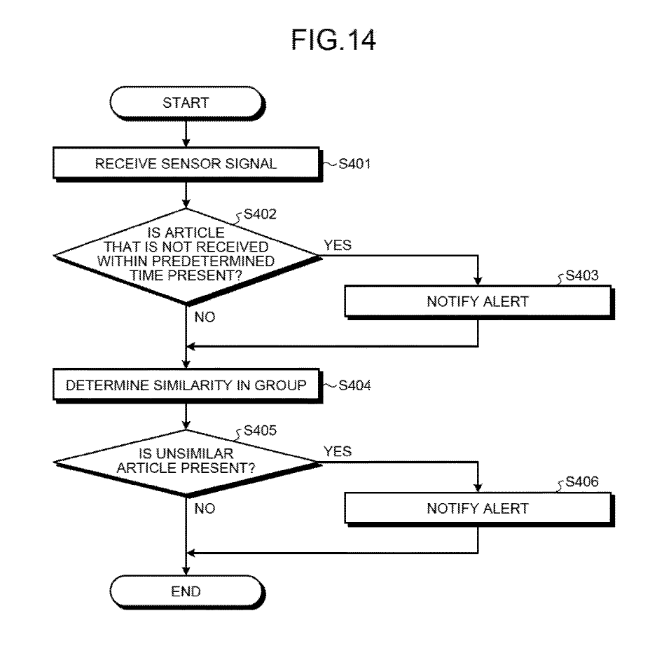

In the following, an alert notification process performed by the mobile terminal device configured as described above will be described with reference to the flowchart illustrated in FIG. 14. The alert notification process described below is performed after, for example, the group lists have been created by the article management process in the first to the third embodiments described above.

After having created the group lists, the sensor signal that includes therein the identification information on the article and the sensor values of the three-axis acceleration sensor is periodically sent from the wireless tag 30 mounted on each of the articles. Then, the sensor signal sent from the wireless tag 30 that is mounted on each of the articles and that is positioned in the communication zone of the mobile terminal device 100 is received by the wireless communication unit 110 (Step S401). The received sensor signal is acquired by the sensor signal acquiring unit 121 in the processor 120.

At this time, if the article of the transmission source of the sensor signal is moving with the article belonging to the same group, the sensor signal in which the article belonging to the same group is the transmission source is expected to be received within the predetermined time. Thus, the group monitoring unit 401 determines whether the sensor signal from the article belonging to the same group as that to which the article of the transmission source of the sensor signal belongs is acquired by the sensor signal acquiring unit 121 within the predetermined time (Step S402).

Consequently, if the article whose sensor signal is not received within the predetermined time is present (Yes at Step S402), it is conceivable that this article is outside the communication zone of the mobile terminal device and is positioned at the location that is different from the position of the article whose sensor signal is received. Thus, an alert indicating that the sensor signal output from the article belonging to the same group as the article of the reception source of the sensor signal is notified by the alert notification unit 402 (Step S403). Namely, for example, a warning message indicating that a change is present in the group is displayed on the display 150 or a warning tone is output from a speaker.

In contrast, if the sensor signals are received from all of the articles belonging to the same group within the predetermined time (No at Step S402), similarly to the first to the third embodiments, the similarity of the movement state of each of the articles is determined by the similarity determination unit 123 (Step S404). Then, the group monitoring unit 401 determines whether the movement states of all of the articles belonging to the same group are similar (Step S405).

If the result indicates that the article whose movement state is not similar is present in the same group (Yes at Step S405), it is conceivable that this article is not moving with the other articles belonging to the same group. Consequently, an alert indicating that the article whose movement state is not similar is present in the group is notified by the alert notification unit 402 (Step S406). Namely, for example, a warning message indicating that a change is present in the group is displayed on the display 150 or a warning tone is output from a speaker.

In contrast, if the movement states of all of the articles belonging to the same group are similar (No at Step S405), because no change is present in the already created group lists, the process is completed without notifying of an alert.

In this way, when the sensor signal from the article is received after the group lists have been created, if the sensor signal from the article belonging to the same group as the subject article is not received or if the movement states of the articles belonging to the same group as the subject article are not similar, an alert is notified. Consequently, the user can be aware that the articles belonging to the same group are not moving together and can prevent the article, for example, that is to be simultaneously carried from being left behind. Furthermore, if an alert is notified, a group list may also be again created by the group list creating unit 125 or the group list may also be changed in accordance with the operation input of the user performed via the input I/F 140.

As described above, according to the embodiment, after the group lists have been created, whether or not the articles in each of the groups are moving together is monitored and, if there is the article that is not moving together, an alert is notified. Consequently, the user can be aware that the articles belonging to the same group are not moving together and can prevent the article, for example, that is to be simultaneously carried from being left behind.

Furthermore, in the fourth embodiment, the levels that are used to associate the pieces of the identification information stored in the group list may also be stored and the presence or absence of the alert or the intensity may also be changed in accordance with the associated levels. Specifically, if the level that is used to associate the identification information on, for example, the article or information on the type is input by a user, a group list in which the pieces of the identification information on the articles are associated in accordance with the input information is created.

Then, in this group list, for example, the levels that indicate strength and weakness of the association between the pieces of the identification information on the articles are stored. At this time, creating the group list is performed by the group list creating unit 125 and, if the information that indicates the level or the type of the association of the identification information is received by the input I/F 140, this information may also additionally be stored in the group list. Then, whether or not the articles in each of the groups are continuously moving together is monitored, if there is the article that is not moving together, the intensity of the alert is changed in accordance with the associated level. Namely, for example, if the articles that are strongly associated with each other are not moving together, a strong alert may be notified by using a sound and a display and, if the articles that are weakly associated with each other are not moving together, a weak alert may also be notified by using only a display.

### [e] Fifth Embodiment

The characteristic of a second embodiment is that a group list is created by a category, such as the weather, the date, or the like.

The configuration of a mobile terminal device according to the fifth embodiment is the same as that of the mobile terminal device 100 (FIG. 2) according to the first embodiment; therefore, descriptions thereof will be omitted. In the fifth embodiment, the function of the processor 120 is different from that described in the first embodiment.

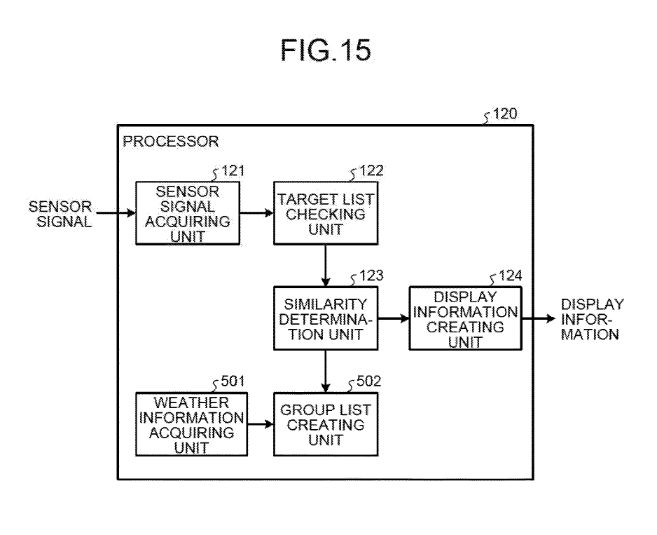

FIG. 15 is a block diagram illustrating the function of the processor 120 according to a fifth embodiment. In FIG. 15, components having the same configuration as those illustrated in FIG. 3 are assigned the same reference numerals and descriptions thereof will be omitted. The processor 120 illustrated in FIG. 15 has the configuration in which a weather information acquiring unit 501 is added to the processor 120 illustrated in FIG. 3 and the group list creating unit 125 is changed to a group list creating unit 502.

The weather information acquiring unit 501 acquires, by connecting to a predetermined server via, for example, the Internet, the current weather information on the current location. Furthermore, the weather information acquiring unit 501 may also share the weather information acquired by another application stored in the mobile terminal device or may also acquire the weather information from, for example, a predetermined sensor. As the weather information, for example, information indicating the type of the weather, such as sunny, cloudy, rainy, or the like, is acquired. This weather information indicates the type of the weather at the time when the movement state of the article is in the movement state indicated by the sensor value that is included in the sensor signal.

The group list creating unit 502 creates, on the basis of the determination result obtained by the similarity determination unit 123, a group list that indicates a group of the articles for each category indicated by the weather information. Specifically, the group list creating unit 502 associates, for each article, with the type of the current weather, the group list that indicates the list of the articles that have the movement state similar to that of the subject article. Accordingly, if, for example, the type of the current weather is “sunny”, the group list creating unit 502 sets the group list that indicates the list of the articles that are determined to be moved together as the group list used for the category of “sunny”.

Furthermore, after the display information created by the display information creating unit 124 is displayed on the display 150, the group list creating unit 502 may also change the group list in accordance with the operation input that is performed by the user and that is received by the input I/F 140. Furthermore, in addition to the weather information, the group list creating unit 502 may also classify the category by using, for example, the date, a day of the week, or the like and create a group list used for each category. Thus, the group list creating unit 502 may also create a group list for each category, such as, for example, a “weekday”, a “holiday”, or the like or may also create a group list for each complex category, such as, for example, a “sunny holiday” or the like.

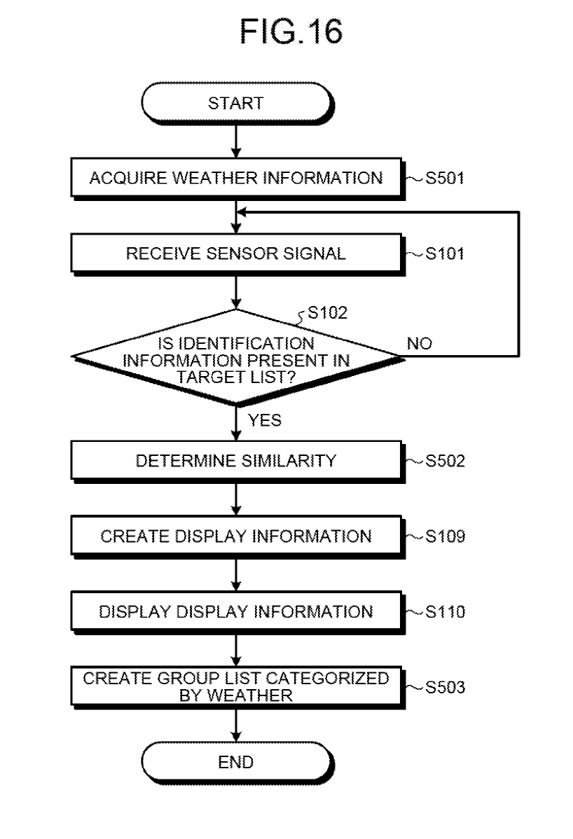

In the following, an article management process performed by the mobile terminal device configured as described above will be described with reference to the flowchart illustrated in FIG. 16. In FIG. 16, components having the same configuration as those illustrated in FIG. 7 are assigned the same reference numerals and descriptions thereof in detail will be omitted.

In the embodiment, the current weather information on the current location is acquired by the weather information acquiring unit 501 (Step S501). The weather information may also be acquired from a predetermined server via, for example, the Internet or may also be acquired from a predetermined sensor included in the mobile terminal device.

In contrast, the sensor signal the sensor signal sent from the wireless tag 30 that is mounted on each of the articles and that is positioned in the communication zone of the mobile terminal device 100 is received by the wireless communication unit 110 (Step S101). Then, the identification information included in the sensor signal is checked against the identification information in the target list by the target list checking unit 122 in the processor 120 (Step S102).

If the result of checking against the target list indicates that the identification information included in the sensor signal is not included in the target list (No at Step S102), the article of the transmission source of this sensor signal is the article or the like that is not, for example, the personal belongings of the user; therefore, the article is ignored as the out of the management target. In contrast, if the identification information included in the sensor signal is included in the target list (Yes at Step S102), similarly to the first to the third embodiments, it is determined, on the basis of the sensor value for each article, whether the movement states of the respective articles are similar (Step S502). Namely, if a difference of the movement likelihood for each article is less than the predetermined threshold, it is determined that the movement states of these articles are similar or, if the spectra of the waveforms of the sensor values in the movement periods for each of the articles are similar, it is determined that the movement states of these articles are similar.

Then, display information on the basis of the determination result of the similarity is created by the display information creating unit 124 (Step S109). The display information created by the display information creating unit 124 is output to the display 150 and displayed (Step S110). Because the display information is displayed on the display 150, a user can visually confirm the group of the articles that have the similar movement states. Consequently, the user can input, to the input I/F 140, the combination or the like of the articles desired to be added to the same group regardless of, for example, the movement state.

In contrast, if the determination result of the similarity of the movement states of the articles is output to the group list creating unit 502, a group list categorized by the weather is created by the group list creating unit 502 (Step S503). Specifically, on the basis of the weather information acquired by the weather information acquiring unit 501, the group list of the articles is associated with the current weather at the current location. Furthermore, the group list may also be associated with the category that is in accordance with, other than the weather, the date or a day of the week. Furthermore, for example, the category that is in accordance with the schedule of a user may also be associated with the group list. Namely, if schedule information on the user is acquired from a predetermined application or the like and if, for example, the current schedule of the user is a “business trip”, the group list may also be associated with the category of the “business trip”.

When creating such a group list, if an operation input is input to the input I/F 140 by the user who visually confirms the display information, the group list is changed in accordance with the operation input performed by the user. Namely, due to the operation performed by the user, the article belonging to the group list is changed or the group list is associated with the category, such as the weather, or the like.

As described above, according to the embodiment, the current weather information on the current location is acquired and the group list of the articles that have similar movement states is associated for each category, such as the weather, or the like. Consequently, the articles that are simultaneously carried by the user can be collectively managed, for each category, in the same group and the articles on each of which the wireless tag is mounted can be efficiently managed.

Furthermore, the fourth and the fifth embodiments described above can be implemented in combination. Namely, it is monitored whether all of the articles belonging to the group list associated with the current weather at the current location are continuously moving together and, if there is the article that is not moving together, it is also possible to notify of, for example, an alert. Consequently, it is possible to prevent the article that is to be simultaneously carried for each category, such as the weather, the date, or the like, from being left behind.

Furthermore, in each of the embodiments described above, the wireless tag 30 includes the three-axis acceleration sensor; however, the wireless tag 30 may also include another sensor as long as the sensor can detect the movement state indicating whether the article is moving or standing still. An example of such a sensor includes a gyro sensor, a geomagnetic sensor, or the like. Furthermore, the wireless tag 30 may also include, as a sensor that detects a movement of the article, a global positioning system (GPS) receiving apparatus, or the like.

Similarly, the wireless tag 30 may also include a wireless interface that is different from the BLE. Namely, the wireless tag 30 may also include a wireless interface that can perform near field wireless communication, such as infrared communication, Wi-Fi Direct (registered trademark), or the like.

Furthermore, the article management process and the alert notification process described in each of the embodiments described above may also be described as a program that can be executed by a computer. In this case, the program may also be stored in a computer readable recording medium and installed in the computer. Examples of the computer readable recording medium include a portable recording medium, such as a CD-ROM, a DVD disk, a USB memory, and the like or a semiconductor memory, such as a flash memory and the like.

According to an aspect of an embodiment of the article management program, the mobile terminal device, and the article management method, an advantage is provided in that it is efficiently manage articles on each of which a wireless tag is mounted.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an article management program that causes a computer to execute a process comprising:
receiving, from a plurality of articles each including a sensor that detects a movement state of each of the articles, a sensor signal that includes therein identification information on an article and a sensor value of the sensor; and
displaying, based on the received sensor signal, display information that indicates in a comparable way a change in the sensor value related to each of the plurality of the articles and the identification information on each of the articles.

2. The non-transitory computer-readable recording medium according to claim 1, wherein
the displaying includes
determining, based on the sensor value related to each of the plurality of the articles, a similarity of the movement states of the plurality of the articles, and
displaying display information in which changes in the sensor values related to a combination of the articles whose similarity of the movements states satisfies a predetermined criterion are adjacently arranged.

3. The non-transitory computer-readable recording medium according to claim 1, wherein the displaying includes displaying, in an adjacently arranged manner, a plurality of graphs whose similarity of temporal changes of the sensor values exceeds a predetermined similarity or a plurality of graphs whose similarity of temporal changes of the sensor values is the highest.

4. The non-transitory computer-readable recording medium according to claim 1, wherein the process further comprises:
accepting, after the display information is displayed, an operation input that selects the articles; and
storing, in a storing unit in a mutually associated manner in accordance with the accepted operation input, the identification information on the plurality of the selected articles.

5. The non-transitory computer-readable recording medium according to claim 1, wherein the process further comprises:
accepting an input of information that specifies a level or a type of association of the identification information on the plurality of the articles;
storing, in a storing unit in a mutually associated manner in accordance with the input information, the identification information on the plurality of the articles and storing, in the storing unit, the specified level of the association; and
performing, after the identification information on the plurality of the articles is stored in the storing unit, in accordance with detection that a change in the sensor value associated with a part of the identification information on the plurality of the articles does not satisfy a predetermined similarity relationship with a change in the sensor value associated with another part of the identification information on the plurality of the articles, a process in accordance with the level of the association stored in the storing unit.

6. The non-transitory computer-readable recording medium according to claim 5, wherein the process in accordance with the level of the association is output presence/absence control of an alert in accordance with the level or intensity control of an alert in accordance with the level.

7. A non-transitory computer-readable recording medium having stored therein an article management program that causes a computer to execute a process comprising:
receiving, from a plurality of articles each including a sensor that detects a movement state of each of the articles, a sensor signal that includes therein identification information on an article and a sensor value of the sensor;
determining, based on the sensor value included in the received sensor signal, whether the movement states of the plurality of the articles are similar; and
storing, in a storing unit when it is determined that the movement states are similar, the identification information on the plurality of the articles in a mutually associated manner.

8. The non-transitory computer-readable recording medium according to claim 7, wherein
the determining includes
calculating an average value of the sensor values for each article,
calculating, based on a difference between the calculated average value and an instantaneous value of the sensor value for each article, movement likelihood that indicates whether the article is moving, and
determining whether a difference of the movement likelihood calculated for each article is less than a predetermined threshold.

9. The non-transitory computer-readable recording medium according to claim 7, wherein
the determining includes
detecting, for each article, a movement period in which the sensor value is equal to or greater than a predetermined threshold, and
determining whether spectra of waveforms of the sensor values in the movement periods for each detected article are similar.

10. The non-transitory computer-readable recording medium according to claim 7, wherein
the determining includes
detecting, for each article, movement period in which the sensor value is equal to or greater than a predetermined threshold, and
determining whether a starting point and an end point of each of the detected movement periods of the articles are mutually within a predetermined range.

11. The non-transitory computer-readable recording medium according to claim 7, wherein the process further comprises:
receiving a sensor signal from one of the plurality of the articles whose identification information are stored by being mutually associated with each other;
determining whether a sensor signal is received from another article whose identification information is stored by being associated with the identification information of the one of the articles; and
notifying of an alert when it is determined that the sensor signal from the another article is not received.

12. The non-transitory computer-readable recording medium according to claim 7, wherein the process further comprises:
receiving a sensor signal from the plurality of the articles whose identification information are mutually associated with each other;
determining, based on the sensor value included in the received sensor signal, whether the movement states of the plurality of the articles are similar; and
notifying of an alert when it is determined that the movement states of the plurality of the articles are not similar.

13. The non-transitory computer-readable recording medium according to claim 7, wherein the process further comprises:
performing a process of acquiring category information related to weather, date, or a schedule of a user at a time when the movement state of the article is the movement state indicated by the sensor value that is included in the received sensor signal, wherein
the storing includes storing, in the storing unit for each acquired category information, the identification information on the plurality of the articles in a mutually associated manner.

14. A mobile terminal device comprising:
a wireless communication unit that receives, from a plurality of articles each including a sensor that detects a movement state of each of the articles, a sensor signal that includes therein identification information on an article and a sensor value of the sensor;
a memory; and
a processor that is connected to the wireless communication unit and the memory, wherein the processor executes a process comprising:
determining, based on the sensor value included in the sensor signal received by the wireless communication unit, whether the movement states of the plurality of the articles are similar, and
storing, in the memory when it is determined that the movement states are similar, the identification information on the plurality of the articles in a mutually associated manner.

15. An article management method comprising:
receiving, from a plurality of articles each including a sensor that detects a movement state of each of the articles, a sensor signal that includes therein identification information on an article and a sensor value of the sensor;
determining, based on the sensor value included in the received sensor signal, whether the movement states of the plurality of the articles are similar by a processor;
storing, in a storing unit when it is determined that the movement states are similar, the identification information on the plurality of the articles in a mutually associated manner by the processor.
